(19) United States
(12) Patent Application Publication
(10) Pub. No.: US 2026/0118643 A1
(43) Pub. Date: Apr. 30, 2026

(54) OPTICAL IMAGING SYSTEM

(71) Applicant: Samsung Electro-Mechanics Co., Ltd., Suwon-si (KR)

(72) Inventors: Yong Joo JO, Suwon-si (KR); Ji Su LEE, Suwon-si (KR); Jae Hyuk HUH, Suwon-si (KR)

(73) Assignee: Samsung Electro-Mechanics Co., Ltd., Suwon-si (KR)

(21) Appl. No.: 19/244,376

(22) Filed: Jun. 20, 2025

(30) Foreign Application Priority Data
Oct. 29, 2024 (KR) 10-2024-0149391

(51) Int. Cl. G02B 13/00; G02B 1/04; G02B 7/02; G02B 9/64

(52) U.S. Cl. CPC G02B 13/006; G02B 1/041; G02B 7/025; G02B 9/64; G02B 13/0045

(57) ABSTRACT

An optical imaging system includes a first bonded lens, a second bonded lens, and a third bonded lens sequentially disposed in ascending numerical order along an optical axis of the optical imaging system from an object side of the optical imaging system toward an imaging plane and spaced apart from each other by predetermined distances, wherein each of the first bonded lens, the second bonded lens, and the third bonded lens includes a central lens made of a plastic material or a glass material; a lens bonded to an object-side surface of the central lens, having a refractive power, and made of a material different from the material of which the central lens is made; and a lens bonded to an image-side surface of the central lens, having a refractive power, and made of a material different from the material of which the central lens is made.

### CROSS-REFERENCE TO RELATED APPLICATIONS

This application claims the benefit under 35 USC 119 (a) of Korean Patent Application No. 10-2024-0149391 filed on Oct. 29, 2024, in the Korean Intellectual Property Office, the entire disclosure of which is incorporated herein by reference for all purposes.

### BACKGROUND

### 1. Field

The present disclosure relates to an optical imaging system.

### 2. Description of Background

Recent portable terminals are typically provided with cameras including an optical imaging system including a plurality of lenses to enable video calls and image capturing.

Furthermore, as the functionality of cameras in portable terminals gradually increases, a demand for cameras for portable terminals having a high resolution is growing.

In particular, recently image sensors with high pixel counts (e.g., 13 million to 200 million pixels) are being adopted in cameras for portable terminals to realize a clearer image quality.

In addition, as portable terminals are gradually becoming smaller, cameras for portable terminals also need to be slimmer, so the development of an optical imaging system that is slim yet capable of realizing a high resolution is desirable.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first bonded lens, a second bonded lens, and a third bonded lens sequentially disposed in ascending numerical order along an optical axis of the optical imaging system from an object side of the optical imaging system toward an imaging plane of the optical imaging system and spaced apart from each other by predetermined distances along the optical axis, wherein each of the first bonded lens, the second bonded lens, and the third bonded lens includes a central lens made of a plastic material or a glass material; a lens bonded to an object-side surface of the central lens, having a refractive power, and made of a material different from the material of which the central lens is made; and a lens bonded to an image-side surface of the central lens, having a refractive power, and made of a material different from the material of which the central lens is made.

The first bonded lens may have a positive refractive power, the second bonded lens may have a negative refractive power, and the third bonded lens may have a negative refractive power.

The first bonded lens may include a first lens, a second lens, and a third lens sequentially disposed in ascending numerical order along the optical axis from an object side of the first bonded lens toward the imaging plane, the second bonded lens may include a fourth lens, a fifth lens, and a sixth lens sequentially disposed in ascending numerical order along the optical axis from an object side of the second bonded lens toward the imaging plane, the third bonded lens may include a seventh lens, an eighth lens, and a ninth lens sequentially disposed in ascending numerical order along the optical axis from an object side of the third bonded lens toward the imaging plane, and the second lens, the fifth lens, and the eighth lens may be the central lenses of the first bonded lens, the second bonded lens, and the third bonded lens.

The first lens may have a negative refractive power, and the second lens may have a positive refractive power.

The first lens may have a negative refractive power, the second lens may have a positive refractive power, and the fifth lens may have a negative refractive power.

The fifth lens may have a negative refractive power, and one of the fourth lens and the sixth lens may have a positive refractive power, and another one of the fourth lens and the sixth lens may have a negative refractive power.

One of the seventh lens and the eighth lens may have a positive refractive power, and another one of the seventh lens and the eighth lens may have a negative refractive power.

The conditional expression 0<(CTn−1+CTn+1)/CTn<1 (n=2, 5, 8) may be satisfied, where CTn−1 is a thickness of an n−1th lens along the optical axis, CTn is a thickness of an nth lens along the optical axis, and CTn+1 is a thickness of an n+1th lens along the optical axis.

The conditional expressions 0≤|f1/v1−f2/v2|<4 and 0≤|f2/v2−f3/v3|<4 may be satisfied, where f1 is a focal length of the first lens, f2 is a focal length of the second lens, f3 is a focal length of the third lens, v1 is an Abbe number of the first lens, v2 is an Abbe number of the second lens, and v3 is an Abbe number of the third lens.

The conditional expression 0.4<TTL/(2×IMG HT)<1.0 may be satisfied, where TTL is a distance along the optical axis from an object-side surface of the first lens to the imaging plane, and IMG HT is one half of a diagonal length of the imaging plane.

A refractive index of the fifth lens may be greatest among refractive indexes of the first lens to the ninth lens.

The second lens, the fifth lens, and the eighth lens may each be made of a plastic material, and a plastic material of which the fifth lens is made may have optical characteristics that are different from optical characteristics of a plastic material of which the second lens is made, and optical characteristics of a plastic material of which the eighth lens is made.

The first to ninth lenses each may have an aspheric object-side surface and an aspheric image-side surface.

The second lens, the fifth lens, and the eighth lens may be made of respective glass materials having optical characteristics that are different from each other.

Either one or both of an object-side surface and an image-side surface of each of the first lens, the second lens, and the third lens may be a spherical surface.

The first lens may have an aspherical object-side surface and a spherical image-side surface, the second lens may have a spherical object-side surface and a spherical image-side surface, the third lens may have a spherical object-side surface and an aspherical image-side surface, and the fourth lens to the ninth lens each may have an aspherical object-side surface and an aspherical image-side surface.

The first lens, the second lens, the third lens, the seventh lens, the eighth lens, and the ninth lens each may have a convex object-side surface in a paraxial region thereof, and the fourth lens may have a concave object-side surface in a paraxial region thereof.

The first lens, the second lens, the third lens, the seventh lens, and the eighth lens each may have a concave image-side surface in a paraxial region thereof, and the sixth lens may have a convex image-side surface in a paraxial region thereof.

Both the object-side surface and the image-side surface of each of the first bonded lens, the second bonded lens, and the third bonded lens may be aspherical surfaces.

The conditional expression 1.5<f/EPD<2.5 may be satisfied, where f is a total focal length of the optical imaging system, and EPD is a diameter of an entrance pupil of the optical imaging system.

Other features and aspects will be apparent from the following detailed description, the drawings, and the claims.

### BRIEF DESCRIPTION OF DRAWINGS

FIG. 1A is a configuration diagram of an optical imaging system according to a first embodiment of the present disclosure.

FIG. 1B is a diagram illustrating aberration characteristics of the optical imaging system illustrated in FIG. 1A.

FIG. 2A is a configuration diagram of an optical imaging system according to a second embodiment of the present disclosure.

FIG. 2B is a diagram illustrating aberration characteristics of the optical imaging system illustrated in FIG. 2A.

FIG. 3A is a configuration diagram of an optical imaging system according to a third embodiment of the present disclosure.

FIG. 3B is a diagram illustrating aberration characteristics of the optical imaging system illustrated in FIG. 3A.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the optical system configuration diagrams in the drawings, the thickness, size, and shape of a lens may be somewhat exaggerated for clarity of explanation, and in particular, the a spherical or aspherical shape of a lens shown in the optical system configuration diagrams is only an example, and is not limited thereto.

In the present specification, a first lens refers to a lens closest to an object side of an optical imaging system, and an ninth lens refers to a lens closest to an imaging plane (or an image sensor) of the optical imaging system.

In addition, in the present specification, values of a radius of curvature of a surface of a lens or other element, a thickness of a lens or other element, a distance between lenses or other elements, a focal length of a lens, and other dimensions are expressed in mm, and a field-of-view (FOV) is expressed in degrees.

In addition, in a description of a shape of a lens, a statement that a surface of the lens is convex means that a paraxial region of the surface is convex, and a statement that a surface of the lens is concave means that a paraxial region of the surface is concave.

Accordingly, even when it is stated that a surface of a lens is convex, an edge portion of the surface may be concave. Similarly, even when it is stated that a surface of a lens is concave, an edge portion of the surface may be convex.

A paraxial region of a lens surface is a very narrow region of the lens surface near an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

An optical imaging system according to an embodiment of the present disclosure may include nine lenses.

For example, an optical imaging system according to an embodiment of the present disclosure may include a first lens, a second lens, a third lens, a fourth lens, a fifth lens, a sixth lens, a seventh lens, an eighth lens, and a ninth lens sequentially disposed in ascending numerical order along an optical axis of the optical imaging system from an object side of the optical imaging system toward an imaging plane of the optical imaging system.

However, the optical imaging system according to an embodiment of the present disclosure may not consist only of nine lenses, and may further include other components as needed. For example, the optical imaging system may further include an image sensor for converting incident light from a subject into an electrical signal. Additionally, the optical imaging system may further include an infrared blocking filter (hereinafter referred to as a filter) for blocking light within the infrared region from being incident on the image sensor. Additionally, the optical imaging system may further include a stop for controlling an amount of light passing through the optical imaging system.

The first lens, the third lens, the fourth lens, the sixth lens, the seventh lens, and the ninth lens of the optical imaging system according to embodiments of the present disclosure may be made of a polymer material (a material that is distinct from a plastic material mentioned below), and, for example, may have an adhesive characteristic. For example, the first lens, the third lens, the fourth lens, the sixth lens, the seventh lens, and the ninth lens may be made of a liquid ultraviolet (UV) polymer material having a characteristic of solidifying in response to UV light. Additionally, the second lens, the fifth lens, and the eighth lens of the optical imaging system according to embodiments of the present disclosure may be made of a plastic material or a glass material.

In addition, at least one lens among the first to ninth lenses may have an aspherical defined by Equation 1 below:

$$Z = \frac{{cY}^{2}}{1 + \sqrt{1 - ( 1 + K )} {c}^{2} {Y}^{2}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} \qquad ( 1 )$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H, J, and L to P are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

An optical imaging system according to an embodiment of the present disclosure may satisfy any one or any combination of any two or more of the conditional expressions below.

$$0 \leq \vert f 1 / v 1 - f 2 / v 2 \vert < 4 \qquad ( Conditional Expression 1 )$$

$$0 \leq \vert f 2 / v 2 - f 3 / v 3 \vert < 4 \qquad ( Conditional Expression 2 )$$

$$0 < ( C T n - 1 + C T n + 1 ) / CTn < 1 ( n = 2 , 5 , 8 ) \qquad ( Conditional Expression 3 )$$

$$0.6 < TTL / ( 2 \times IMG HT ) < 1. \qquad ( Conditional Expression 4 )$$

$$1.5 < f / EPD < 2.5 \qquad ( Conditional Expression 5 )$$

$$1 < TT L / f < 1.3 \qquad ( Conditional Expression 6 )$$

$$0.1 < B F L / f < 0.2 \qquad ( Conditional Expression 7 )$$

In the conditional expressions, f is a total focal length of the optical imaging system, f1 is a focal length of the first lens, f2 is a focal length of the second lens, and f3 is a focal length of the third lens.

In addition, v1 is an Abbe number of the first lens, v2 is an Abbe number of the second lens, and v3 is an Abbe number of the third lens.

In addition, CTn−1 is a thickness of an n−1th lens along an optical axis, CTn is a thickness of an nth lens along the optical axis, and CTn+1 is a thickness of an n+1th lens along the optical axis.

In addition, TTL is a distance along the optical axis from an object-side surface of the first lens to an imaging plane, BFL is a distance along the optical axis from an image-side surface of the ninth lens to the imaging plane, IMG HT is one half of a diagonal length of the imaging plane, and EPD is a diameter of an entrance pupil of the optical imaging system.

An optical imaging system according to embodiments of the present disclosure may include three bonded lenses. For example, the optical imaging system according to embodiments of the present disclosure may include a first bonded lens, a second bonded lens, and a third bonded lens sequentially disposed in ascending numerical order along an optical axis of the optical imaging system from an object side of the optical imaging system toward an imaging plane of the optical imaging system and spaced apart from each other by predetermined distances along the optical axis.

According to embodiments of the present disclosure, the first to third bonded lenses may include lenses attached to each of both surfaces (an object-side surface and an image-side surface) of a central lens. For example, the first bonded lens may include a second lens that is a central lens, a first lens attached to an object-side surface of the second lens, and a third lens attached to an image-side surface of the second lens. The second bonded lens may include a fifth lens that is a central lens, a fourth lens attached to an object-side surface of the fifth lens, and a sixth lens attached to an image-side surface of the fifth lens. The third bonded lens may include an eighth lens that is a central lens, a seventh lens attached to an object-side surface of the eighth lens, and a ninth lens attached to an image-side surface of the eighth lens.

According to embodiments of the present disclosure, the first lens, the third lens, the fourth lens, the sixth lens, the seventh lens, and the ninth lens attached to the object-side surface or the image-side surface of a central lens may be made of a polymer material (a material distinct from a plastic material mentioned below) having an adhesive characteristic so that they may be directly attached to the object-side surface or the image-side surface of the central lens without using an additional adhesive.

According to embodiments of the present disclosure, the second lens, the fifth lens, and the eighth lens, which are central lenses, may be made of a plastic material or a glass material.

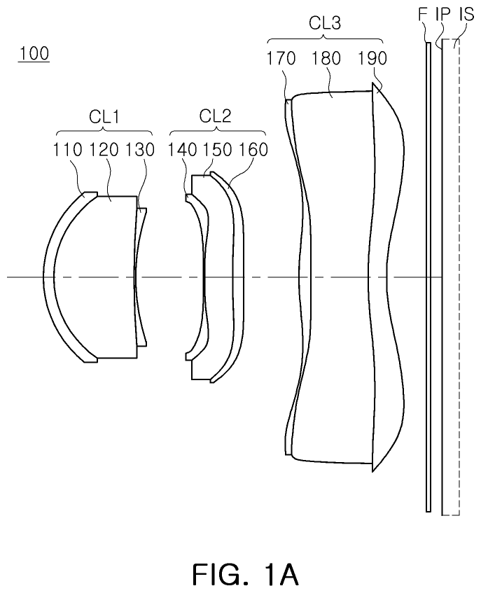

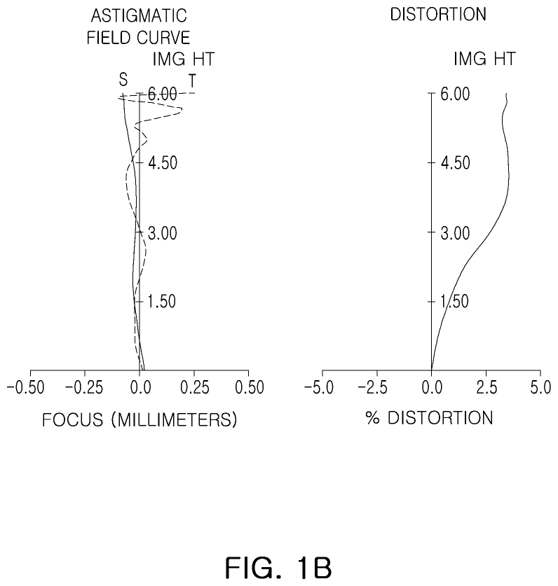

FIG. 1A is a configuration diagram of an optical imaging system according to a first embodiment of the present disclosure, and FIG. 1B is a diagram illustrating aberration characteristics of an optical imaging system illustrated in FIG. 1A.

Referring to FIG. 1A, an optical imaging system 100 according to the first embodiment of the present disclosure may include a first lens 110, a second lens 120, a third lens 130, a fourth lens 140, a fifth lens 150, a sixth lens 160, a seventh lens 170, an eighth lens 180, and a ninth lens 190 sequentially disposed in ascending numerical order along an optical axis of the optical imaging system 100 from an object side of the optical imaging system 100, a filter, and an image sensor IS having an imaging plane IP on which a focus is formed.

A total focal length f of the optical imaging system 100 according to the first embodiment of the present disclosure is 8.91 mm, an IMG HT is 6.00 mm, and an FOV is 66.2°.

The characteristics of each element of the optical imaging system 100 according to the first embodiment of the present disclosure are listed in Table 1 below.

TABLE 1

| Surface | | Radius of | Thickness/ | Refractive | Abbe | Focal |
|---|---|---|---|---|---|---|
| No. | Element | Curvature | Distance | Index | No. | Length |
| S1 | 1st Lens | 3.0222 | 0.2458 | 1.643 | 22.04 | −33.23 |
| S2 | | 2.5661 | 0.0000 | | | |
| S3 | 2nd Lens | 2.5661 | 2.0112 | 1.544 | 55.99 | 5.26 |
| S4 | | 17.3200 | 0.0000 | | | |
| S5 | 3rd Lens | 17.3200 | 0.0544 | 1.607 | 26.94 | −18.46 |
| S6 | | 6.8318 | 1.6804 | | | |
| S7 | 4th Lens | −47.9252 | 0.0500 | 1.643 | 22.05 | −17.89 |
| S8 | | 15.3500 | 0.0000 | | | |
| S9 | 5th Lens | 15.3500 | 0.7053 | 1.661 | 20.38 | −117.42 |
| S10 | | 12.6025 | 0.0000 | | | |
| S11 | 6th Lens | 12.6025 | 0.2900 | 1.557 | 45.40 | 21.89 |
| S12 | | −442.9555 | 1.3617 | | | |
| S13 | 7th Lens | 7.9742 | 0.2980 | 1.660 | 20.38 | 16.51 |
| S14 | | 28.3632 | 0.0000 | | | |
| S15 | 8th Lens | 28.3632 | 1.4621 | 1.544 | 55.99 | −9.82 |
| S16 | | 4.4282 | 0.0000 | | | |
| S17 | 9th Lens | 4.4282 | 0.4500 | 1.614 | 26.35 | 83.57 |
| S18 | | 4.6546 | 0.9999 | | | |
| S19 | Filter | Infinity | 0.1100 | 1.517 | 64.17 | |
| S20 | | Infinity | 0.2711 | | | |
| S21 | Imaging | Infinity | | | | |
| | Plane | | | | | |

According to the first embodiment of the present disclosure, the first lens 110 may have a negative refractive power, an object-side surface may be convex, and an image-side surface may be concave. The second lens 120 may have a positive refractive power, an object-side surface may be convex, and an image-side surface may be concave. The third lens 130 may have a negative refractive power, an object-side surface may be convex, and an image-side surface may be concave. The fourth lens 140 may have a negative refractive power, and an object-side surface and an image-side surface may be concave. The fifth lens 150 may have a negative refractive power, an object-side surface may be convex, and an image-side surface may be concave. The sixth lens 160 may have a positive refractive power, an object-side surface and an image-side surface may be convex. The seventh lens 170 may have a positive refractive power, an object-side surface may be convex, and an image-side surface may be concave. The eighth lens 180 may have a negative refractive power, an object-side surface may be convex, and an image-side surface may be concave. The ninth lens 190 may have a positive refractive power, an object-side surface may be convex, and an image-side surface may be concave.

According to the first embodiment of the present disclosure, the first lens 110, the second lens 120, and the third lens 130 may form a first bonded lens CL1, the fourth lens 140, the fifth lens 150, and the sixth lens 160 may form a second bonded lens CL2, and the seventh lens 170, the eighth lens 180, and the ninth lens 190 may form a third bonded lens CL3.

The first bonded lens CL1 may have a positive refractive power, the second bonded lens CL2 may have a negative refractive power, and the third bonded lens CL3 may have a negative refractive power. A focal length f123 of the first bonded lens CL1 is 8.84 mm, a focal length f456 of the second bonded lens CL2 is-5.77 mm, and a focal length f789 of the third bonded lens CL3 is-47.41 mm.

An object-side surface of the first bonded lens CL1 may be convex, and an image-side surface thereof may be concave. An object-side surface of the second bonded lens CL2 may be concave, and an image-side surface thereof may be convex. An object-side surface of the third bonded lens CL3 may be convex, and an image-side surface thereof may be concave.

According to the first embodiment of the present disclosure, the first lens 110, the third lens 130, the fourth lens 140, the sixth lens 160, the seventh lens 170, and the ninth lens 190 may be made of a polymer material, and the second lens 120, the fifth lens 150, and the eighth lens 180 may be made of a plastic material.

At least one of the second lens 120, the fifth lens 150, and the eighth lens 180 may be made of a plastic material having optical characteristics that are different from optical characteristics of a plastic material of which the remaining lens(es) are made. For example, the fifth lens 150 may be made of a plastic material having optical characteristics that are different from optical characteristics of a plastic material of which the second lens 120 is made, and optical characteristics of a plastic material of which the eighth lens 180 is made. Furthermore, the optical characteristics of the plastic material of which the second lens 120 is made may be different from the optical characteristics of the plastic material of which the eighth lens 180 is made.

The fifth lens 150 may be a high refractive index lens having a refractive index of 1.6 or greater, and among the first lens 110 to the ninth lens 190, the refractive index of the fifth lens 150 may be the greatest.

Among the first lens 110, the second lens 120, and the third lens 130 forming the first bonded lens CL1, a refractive index of the second lens 120 may be the smallest. Among the fourth lens 140, the fifth lens 150, and the sixth lens 160 forming the second bonded lens CL2, a refractive index of the fifth lens 150 may be the greatest. Among the seventh lens 170, the eighth lens 180, and the ninth lens 190 forming the third bonded lens CL3, a refractive index of the eighth lens 180 may be the smallest.

Aspherical coefficients of each lens of the optical imaging system 100 according to the first embodiment of the present disclosure are listed in Table 2 below. According to the first embodiment of the present disclosure, the first lens 110 to the ninth lens 190 may have aspherical surfaces on both surfaces (the object-side surface and the image-side surface), and the first bonded lens CL1, the second bonded lens CL2, and the third bonded lens CL3 may also have aspherical surfaces on both surfaces (the object-side surface and the image-side surface).

TABLE 2

| Surface | | | | | | |
|---|---|---|---|---|---|---|
| No. | S1 | S2 | S3 | S4 | S5 | S6 |
| K | −0.004 | −0.019 | −0.019 | −20.841 | −20.841 | 11.010 |
| A | 1.354E−03 | 3.265E−02 | 3.265E−02 | −4.302E−02 | −4.302E−02 | −1.551E−02 |
| B | −5.972E−03 | −1.887E−01 | −1.887E−01 | 9.409E−02 | 9.409E−02 | 7.815E−02 |
| C | 8.959E−03 | 5.366E−01 | 5.366E−01 | 5.732E−01 | 5.732E−01 | −2.117E−01 |
| D | −1.887E−03 | −9.140E−01 | −9.140E−01 | −3.615E+00 | −3.615E+00 | 2.921E−01 |
| E | −1.218E−02 | 1.018E+00 | 1.018E+00 | 9.387E+00 | 9.387E+00 | −1.267E−01 |
| F | 1.986E−02 | −7.782E−01 | −7.782E−01 | −1.458E+01 | −1.458E+01 | −2.420E−01 |
| G | −1.634E−02 | 4.189E−01 | 4.189E−01 | 1.500E+01 | 1.500E+01 | 5.056E−01 |
| H | 8.514E−03 | −1.603E−01 | −1.603E−01 | −1.069E+01 | −1.069E+01 | −4.777E−01 |
| J | −2.996E−03 | 4.331E−02 | 4.331E−02 | 5.355E+00 | 5.355E+00 | 2.803E−01 |
| L | 7.245E−04 | −8.071E−03 | −8.071E−03 | −1.884E+00 | −1.884E+00 | −1.092E−01 |
| M | −1.189E−04 | 9.845E−04 | 9.845E−04 | 4.558E−01 | 4.558E−01 | 2.833E−02 |
| N | 1.267E−05 | −7.032E−05 | −7.032E−05 | −7.222E−02 | −7.222E−02 | −4.724E−03 |
| O | −7.919E−07 | 2.166E−06 | 2.166E−06 | 6.749E−03 | 6.749E−03 | 4.585E−04 |
| P | 2.204E−08 | 7.083E−09 | 7.083E−09 | −2.820E−04 | −2.820E−04 | −1.972E−05 |

| Surface | | | | | | |
|---|---|---|---|---|---|---|
| No. | S7 | S8 | S9 | S10 | S11 | S12 |
| K | 99.000 | −16.767 | −16.767 | −40.548 | −40.548 | 99.000 |
| A | 1.012E−02 | −5.508E−01 | −5.508E−01 | −2.585E−02 | −2.585E−02 | −1.343E−02 |
| B | −1.476E−01 | 2.945E+00 | 2.945E+00 | 8.385E−03 | 8.385E−03 | 3.043E−03 |
| C | 4.539E−01 | −7.726E+00 | −7.726E+00 | 3.882E−02 | 3.882E−02 | −8.453E−03 |
| D | −8.769E−01 | 1.246E+01 | 1.246E+01 | −9.199E−02 | −9.199E−02 | 1.392E−02 |
| E | 1.156E+00 | −1.352E+01 | −1.352E+01 | 9.569E−02 | 9.569E−02 | −1.253E−02 |
| F | −1.089E+00 | 1.040E+01 | 1.040E+01 | −5.927E−02 | −5.927E−02 | 7.064E−03 |
| G | 7.493E−01 | −5.849E+00 | −5.849E+00 | 2.421E−02 | 2.421E−02 | −2.700E−03 |
| H | −3.795E−01 | 2.432E+00 | 2.432E+00 | −6.841E−03 | −6.841E−03 | 7.311E−04 |
| J | 1.411E−01 | −7.471E−01 | −7.471E−01 | 1.366E−03 | 1.366E−03 | −1.430E−04 |
| L | −3.795E−02 | 1.674E−01 | 1.674E−01 | −1.930E−04 | −1.930E−04 | 2.021E−05 |
| M | 7.177E−03 | −2.654E−02 | −2.654E−02 | 1.894E−05 | 1.894E−05 | −2.019E−06 |
| N | −9.042E−04 | 2.820E−03 | 2.820E−03 | −1.230E−06 | −1.230E−06 | 1.355E−07 |
| O | 6.805E−05 | −1.798E−04 | −1.798E−04 | 4.770E−08 | 4.770E−08 | −5.487E−09 |
| P | −2.313E−06 | 5.197E−06 | 5.197E−06 | −8.361E−10 | −8.361E−10 | 1.011E−10 |
| Surface | | | | | | |
| No. | S13 | S14 | S15 | S16 | S17 | S18 |
| K | −99.000 | 14.704 | 14.704 | −67.316 | −67.316 | −9.386 |
| A | 7.926E−03 | −1.252E−02 | −1.252E−02 | −4.951E−03 | −4.951E−03 | −5.982E−03 |
| B | −9.506E−03 | −6.478E−04 | −6.478E−04 | −8.989E−04 | −8.989E−04 | −3.456E−03 |
| C | 4.214E−03 | 1.500E−03 | 1.500E−03 | 4.737E−04 | 4.737E−04 | −1.972E−03 |
| D | −1.261E−03 | −7.706E−04 | −7.706E−04 | 1.081E−04 | 1.081E−04 | 6.751E−04 |
| E | 2.671E−04 | 2.358E−04 | 2.358E−04 | −9.348E−05 | −9.348E−05 | −1.469E−04 |
| F | −4.069E−05 | −4.627E−05 | −4.627E−05 | 2.391E−05 | 2.391E−05 | 2.143E−05 |
| G | 4.505E−06 | 6.059E−06 | 6.059E−06 | −3.428E−06 | −3.428E−06 | −2.170E−06 |
| H | −3.640E−07 | −5.403E−07 | −5.403E−07 | 3.151E−07 | 3.151E−07 | 1.556E−07 |
| J | 2.136E−08 | 3.284E−08 | 3.284E−08 | −1.953E−08 | −1.953E−08 | −7.954E−09 |
| L | −8.972E−10 | −1.332E−09 | −1.332E−09 | 8.278E−10 | 8.278E−10 | 2.878E−10 |
| M | 2.610E−11 | 3.397E−11 | 3.397E−11 | −2.370E−11 | −2.370E−11 | −7.199E−12 |
| N | −4.956E−13 | −4.698E−13 | −4.698E−13 | 4.392E−13 | 4.392E−13 | 1.184E−13 |
| O | 5.453E−15 | 1.895E−15 | 1.895E−15 | −4.758E−15 | −4.758E−15 | −1.152E−15 |
| P | −2.582E−17 | 1.732E−17 | 1.732E−17 | 2.290E−17 | 2.290E−17 | 5.020E−18 |

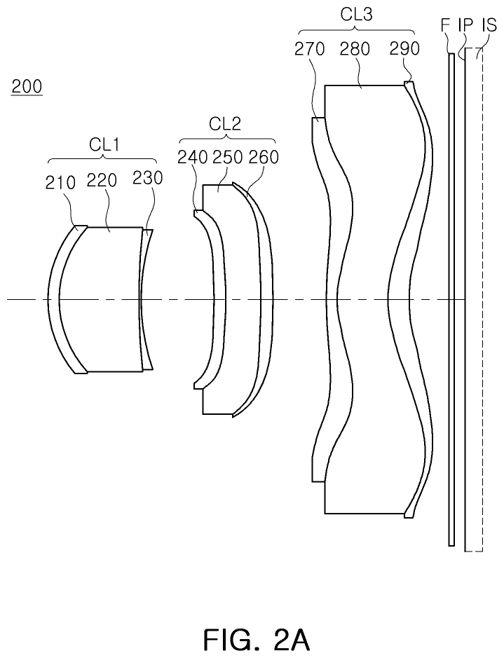

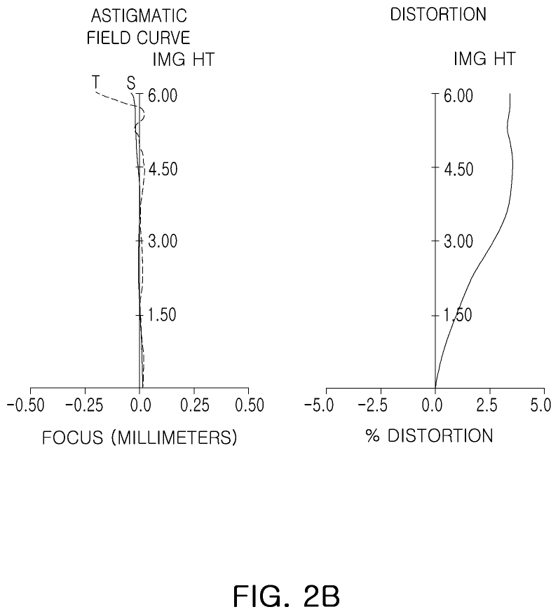

FIG. 2A is a configuration diagram of an optical imaging system according to a second embodiment of the present disclosure, and FIG. 2B is a diagram illustrating aberration characteristics of the optical imaging system illustrated in FIG. 2A.

Referring to FIG. 2A, an optical imaging system 200 according to the second embodiment of the present disclosure may include a first lens 210, a second lens 220, a third lens 230, a fourth lens 240, a fifth lens 250, a sixth lens 260, a seventh lens 270, an eighth lens 280, and a ninth lens 290 sequentially disposed in ascending numerical order along an optical axis of the optical imaging system 200 from an object side of the optical imaging system 200, a filter, and an image sensor IS having an imaging plane IP on which a focus is formed.

A total focal length f of the optical imaging system 200 according to the second embodiment of the present disclosure is 8.97 mm, an IMG HT is 6.00 mm, and an FOV is 65.8°.

The characteristics of each element of the optical imaging system 200 according to the second embodiment of the present disclosure are listed in Table 3 below.

TABLE 3

| Surface | | Radius of | Thickness/ | Refractive | Abbe | Focal |
|---|---|---|---|---|---|---|
| No. | Element | Curvature | Distance | Index | No. | Length |
| S1 | 1st Lens | 3.0835 | 0.2377 | 1.592 | 30.03 | −46.57 |
| S2 | | 2.6954 | 0.0000 | | | |
| S3 | 2nd Lens | 2.6954 | 2.0100 | 1.544 | 55.99 | 5.40 |
| S4 | | 23.0416 | 0.0000 | | | |
| S5 | 3rd Lens | 23.0416 | 0.0300 | 1.643 | 22.13 | −15.49 |
| S6 | | 7.0026 | 1.8014 | | | |
| S7 | 4th Lens | −23.4165 | 0.2938 | 1.602 | 27.91 | 33.34 |
| S8 | | −10.9054 | 0.0000 | | | |
| S9 | 5th Lens | −10.9054 | 0.8800 | 1.661 | 20.38 | −35.54 |
| S10 | | −20.8141 | 0.0000 | | | |
| S11 | 6th Lens | −20.8141 | 0.3000 | 1.546 | 54.17 | −130.47 |
| S12 | | −29.5055 | 1.3208 | | | |
| S13 | 7th Lens | 6.5516 | 0.2627 | 1.580 | 34.60 | −5.56 |
| S14 | | 2.1402 | 0.0000 | | | |
| S15 | 8th Lens | 2.1402 | 1.2703 | 1.544 | 55.99 | 9.16 |
| S16 | | 2.9562 | 0.0000 | | | |
| S17 | 9th Lens | 2.9562 | 0.5315 | 1.660 | 20.38 | 12.94 |
| S18 | | 4.1692 | 1.0000 | | | |
| S19 | Filter | Infinity | 0.1100 | 1.517 | 64.17 | |
| S20 | | Infinity | 0.2520 | | | |
| S21 | Imaging | Infinity | | | | |
| | Plane | | | | | |

According to the second embodiment of the present disclosure, the first lens 210 may have a negative refractive power, an object-side surface may be convex, and an image-side surface may be concave. The second lens 220 may have a positive refractive power, an object-side surface may be convex, and an image-side surface may be concave. The third lens 230 may have a negative refractive power, an object-side surface may be convex, and an image-side surface may be concave. The fourth lens 240 may have a positive refractive power, and an object-side surface may be concave, and an image-side surface may be convex. The fifth lens 250 may have a negative refractive power, an object-side surface may be concave, and an image-side surface may be convex. The sixth lens 260 may have a negative refractive power, an object-side surface may be concave, and an image-side surface may be convex. The seventh lens 270 may have a negative refractive power, an object-side surface may be convex, and an image-side surface may be concave. The eighth lens 280 may have a positive refractive power, an object-side surface may be convex, and an image-side surface may be concave. The ninth lens 290 may have a positive refractive power, an object-side surface may be convex, and an image-side surface may be concave.

According to the second embodiment of the present disclosure, the first lens 210, the second lens 220, and the third lens 230 may form a first bonded lens CL1, the fourth lens 240, the fifth lens 250, and the sixth lens 260 may form a second bonded lens CL2, and the seventh lens 270, the eighth lens 280, and the ninth lens 290 may form a third bonded lens CL3.

The first bonded lens CL1 may have a positive refractive power, the second bonded lens CL2 may have a negative refractive power, and the third bonded lens CL3 may have a negative refractive power. A focal length f123 of the first bonded lens CL1 is 9.10 mm, a focal length f456 of the second bonded lens CL2 is-151.10 mm, and a focal length f789 of the third bonded lens CL3 is-30.37 mm.

An object-side surface of the first bonded lens CL1 may be convex, and an image-side surface thereof may be concave. An object-side surface of the second bonded lens CL2 may be concave, and an image-side surface thereof may be convex. An object-side surface of the third bonded lens CL3 may be convex, and an image-side surface thereof may be concave.

According to the second embodiment of the present disclosure, the first lens 210, the third lens 230, the fourth lens 240, the sixth lens 260, the seventh lens 270, and the ninth lens 290 may be made of a polymer material, and the second lens 220, the fifth lens 250, and the eighth lens 280 may be made of a plastic material.

At least one of the second lens 220, the fifth lens 250, and the eighth lens 280 may be made of a plastic material having optical characteristics that are different from optical characteristics of a plastic material of which the remaining lens(es) are made. For example, the fifth lens 250 may be made of a plastic material having optical characteristics that are different from optical characteristics of a plastic material of which the second lens 220 is made, and optical characteristics of a plastic material of which the eighth lens 280 is made. Furthermore, the optical characteristics of the plastic material of which the second lens 220 is made may be different from the optical characteristics of the plastic material of which the eighth lens 280 is made.

The fifth lens 250 may be a high refractive index lens having a refractive index of 1.6 or greater, and among the first lens 210 to the ninth lens 290, the refractive index of the fifth lens 250 may be the greatest.

Among the first lens 210, the second lens 220, and the third lens 230 forming the first bonded lens CL1, a refractive index of the second lens 220 may be the smallest. Among the fourth lens 240, the fifth lens 250, and the sixth lens 260 forming the second bonded lens CL2, a refractive index of the fifth lens 250 may be the greatest. Among the seventh lens 270, the eighth lens 280, and the ninth lens 290 forming the third bonded lens CL3, a refractive index of the eighth lens 280 may be the smallest.

Aspherical coefficients of each lens of the optical imaging system 200 according to the second embodiment of the present disclosure are listed in Table 4 below. According to the second embodiment of the present disclosure, the first lens 210 to ninth lens 290 may have aspherical surfaces on both surfaces (the object-side surface and the image-side surface), and the first bonded lens CL1, the second bonded lens CL2, and the third bonded lens CL3 may also have aspherical surfaces on both surfaces (the object-side surface and the image-side surface).

TABLE 4

| Surface | | | | | | |
|---|---|---|---|---|---|---|
| No. | S1 | S2 | S3 | S4 | S5 | S6 |
| K | 0.016 | −0.066 | −0.066 | −91.475 | −91.475 | 11.629 |
| A | 1.174E−03 | 2.181E−02 | 2.181E−02 | 3.996E−04 | 3.996E−04 | −4.107E−03 |
| B | −4.097E−03 | −1.958E−01 | −1.958E−01 | −6.055E−03 | −6.055E−03 | 2.098E−02 |
| C | 9.517E−03 | 1.054E+00 | 1.054E+00 | −1.047E−01 | −1.047E−01 | −1.107E−01 |
| D | −1.317E−02 | −3.422E+00 | −3.422E+00 | 8.261E−01 | 8.261E−01 | 3.910E−01 |
| E | 8.344E−03 | 7.123E+00 | 7.123E+00 | −2.584E+00 | −2.584E+00 | −9.003E−01 |
| F | 4.422E−03 | −9.982E+00 | −9.982E+00 | 4.639E+00 | 4.639E+00 | 1.387E+00 |
| G | −1.497E−02 | 9.729E+00 | 9.729E+00 | −5.386E+00 | −5.386E+00 | −1.476E+00 |
| H | 1.573E−02 | −6.720E+00 | −6.720E+00 | 4.259E+00 | 4.259E+00 | 1.107E+00 |
| J | −9.781E−03 | 3.309E+00 | 3.309E+00 | −2.343E+00 | −2.343E+00 | −5.881E−01 |
| L | 3.961E−03 | −1.154E+00 | −1.154E+00 | 8.967E−01 | 8.967E−01 | 2.202E−01 |
| M | −1.058E−03 | 2.784E−01 | 2.784E−01 | −2.343E−01 | −2.343E−01 | −5.675E−02 |
| N | 1.800E−04 | −4.419E−02 | −4.419E−02 | 3.983E−02 | 3.983E−02 | 9.571E−03 |
| O | −1.773E−05 | 4.151E−03 | 4.151E−03 | −3.970E−03 | −3.970E−03 | −9.499E−04 |
| P | 7.696E−07 | −1.749E−04 | −1.749E−04 | 1.760E−04 | 1.760E−04 | 4.204E−05 |

| Surface | | | | | | |
|---|---|---|---|---|---|---|
| No. | S7 | S8 | S9 | S10 | S11 | S12 |
| K | 99.000 | 19.123 | 19.123 | 25.213 | 25.213 | 98.800 |
| A | −7.681E−03 | −1.455E−02 | −1.455E−02 | 2.823E−02 | 2.823E−02 | −1.947E−02 |
| B | −1.534E−02 | 5.763E−02 | 5.763E−02 | −8.938E−02 | −8.938E−02 | 1.639E−02 |
| C | 5.627E−02 | −2.646E−01 | −2.646E−01 | 1.205E−01 | 1.205E−01 | −1.763E−02 |
| D | −1.224E−01 | 6.007E−01 | 6.007E−01 | −8.952E−02 | −8.952E−02 | 1.114E−02 |
| E | 1.636E−01 | −7.502E−01 | −7.502E−01 | 3.794E−02 | 3.794E−02 | −3.695E−03 |
| F | −1.454E−01 | 5.832E−01 | 5.832E−01 | −7.732E−03 | −7.732E−03 | 2.379E−04 |
| G | 9.000E−02 | −2.998E−01 | −2.998E−01 | −5.458E−04 | −5.458E−04 | 3.271E−04 |
| H | −3.975E−02 | 1.041E−01 | 1.041E−01 | 8.314E−04 | 8.314E−04 | −1.575E−04 |
| J | 1.263E−02 | −2.409E−02 | −2.409E−02 | −2.589E−04 | −2.589E−04 | 3.842E−05 |
| L | −2.865E−03 | 3.496E−03 | 3.496E−03 | 4.575E−05 | 4.575E−05 | −5.889E−06 |
| M | 4.529E−04 | −2.563E−04 | −2.563E−04 | −5.107E−06 | −5.107E−06 | 5.894E−07 |
| N | −4.737E−05 | −2.468E−06 | −2.468E−06 | 3.576E−07 | 3.576E−07 | −3.757E−08 |
| O | 2.943E−06 | 1.865E−06 | 1.865E−06 | −1.441E−08 | −1.441E−08 | 1.390E−09 |
| P | −8.221E−08 | −9.717E−08 | −9.717E−08 | 2.556E−10 | 2.556E−10 | −2.274E−11 |

| Surface | | | | | | |
|---|---|---|---|---|---|---|
| No. | S13 | S14 | S15 | S16 | S17 | S18 |
| K | −71.783 | −11.884 | −11.884 | −6.287 | −6.287 | −6.931 |
| A | 6.779E−03 | 1.666E−02 | 1.666E−02 | 1.298E−02 | 1.298E−02 | −3.919E−04 |
| B | −8.988E−03 | −3.038E−02 | −3.038E−02 | −1.448E−02 | −1.448E−02 | −1.675E−03 |
| C | 3.830E−03 | 2.181E−02 | 2.181E−02 | 8.111E−03 | 8.111E−03 | 6.239E−04 |
| D | −1.125E−03 | −9.077E−03 | −9.077E−03 | −2.668E−03 | −2.668E−03 | −1.474E−04 |
| E | 2.373E−04 | 2.345E−03 | 2.345E−03 | 5.606E−04 | 5.606E−04 | 2.517E−05 |
| F | −3.641E−05 | −3.975E−04 | −3.975E−04 | −7.988E−05 | −7.988E−05 | −3.205E−06 |
| G | 4.103E−06 | 4.578E−05 | 4.578E−05 | 8.004E−06 | 8.004E−06 | 3.034E−07 |
| H | −3.407E−07 | −3.636E−06 | −3.636E−06 | −5.750E−07 | −5.750E−07 | −2.117E−08 |
| J | 2.078E−08 | 1.985E−07 | 1.985E−07 | 2.978E−08 | 2.978E−08 | 1.078E−09 |
| L | −9.179E−10 | −7.254E−09 | −7.254E−09 | −1.104E−09 | −1.104E−09 | −3.947E−11 |
| M | 2.855E−11 | 1.652E−10 | 1.652E−10 | 2.856E−11 | 2.856E−11 | 1.010E−12 |
| N | −5.915E−13 | −1.933E−12 | −1.933E−12 | −4.901E−13 | −4.901E−13 | −1.716E−14 |
| O | 7.312E−15 | 2.660E−15 | 2.660E−15 | 5.016E−15 | 5.016E−15 | 1.737E−16 |
| P | −4.064E−17 | 1.198E−16 | 1.198E−16 | −2.318E−17 | −2.318E−17 | −7.940E−19 |

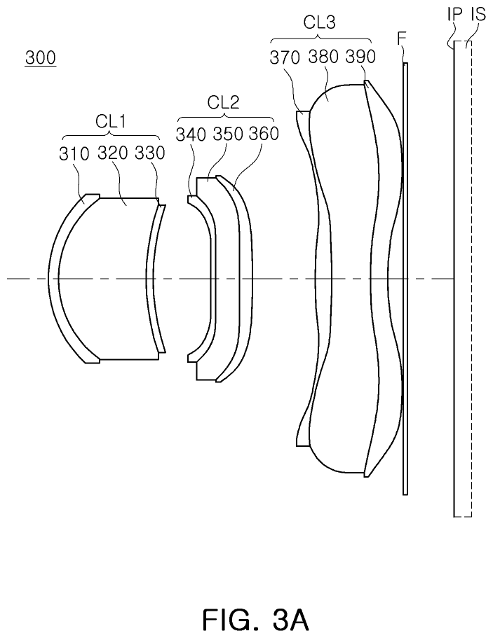

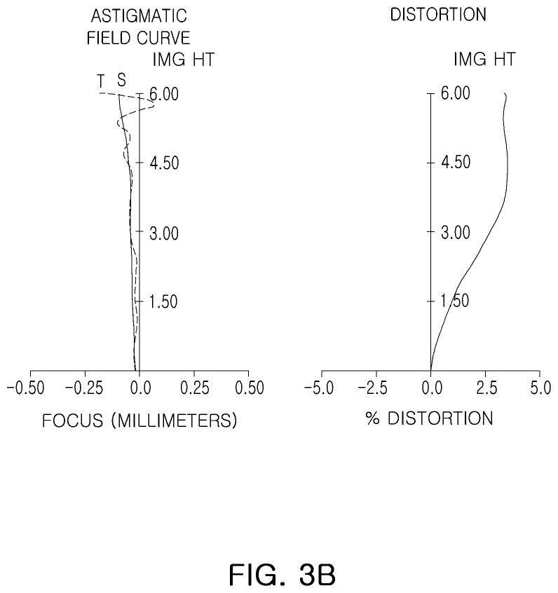

FIG. 3A is a configuration diagram of an optical imaging system according to a third embodiment of the present disclosure, and FIG. 3B is a diagram illustrating aberration characteristics of the optical imaging system illustrated in FIG. 3A.

Referring to FIG. 3A, an optical imaging system 300 according to a third embodiment of the present disclosure may include a first lens 310, a second lens 320, a third lens 330, a fourth lens 340, a fifth lens 350, a sixth lens 360, a seventh lens 370, an eighth lens 380, and a ninth lens 390 sequentially disposed in ascending numerical order along an optical axis of the optical imaging system 300 from an object side of the optical imaging system 300, a filter, and an image sensor IS having an imaging plane IP on which a focus is formed.

A total focal length f of the optical imaging system 300 according to the third embodiment of the present disclosure is 9.31 mm, an IMG HT is 6.00 mm, and an FOV is 63.8°.

The characteristics of each element of the optical imaging system 300 according to the third embodiment of the present disclosure are listed in Table 5 below.

TABLE 5

| Surface | | Radius of | Thickness/ | Refractive | Abbe | Focal |
|---|---|---|---|---|---|---|
| No. | Element | Curvature | Distance | Index | No. | Length |
| S1 | 1st | 2.9913 | 0.2451 | 1.659 | 20.47 | −51.04 |
| S2 | Lens | 2.6596 | 0.0000 | | | |
| S3 | 2nd | 2.6596 | 2.2275 | 1.497 | 81.56 | 7.53 |
| S4 | Lens | 6.5817 | 0.0000 | | | |
| S5 | 3rd | 6.5817 | 0.1626 | 1.546 | 53.89 | 186.54 |
| S6 | Lens | 6.9728 | 1.4743 | | | |
| S7 | 4th | −28.0716 | 0.0801 | 1.630 | 23.52 | −825.27 |
| S8 | Lens | −29.6899 | 0.0000 | | | |
| S9 | 5th | −29.6899 | 0.5985 | 1.664 | 32.57 | −13.63 |
| S10 | Lens | 13.2451 | 0.0000 | | | |
| S11 | 6th | 13.2451 | 0.3501 | 1.544 | 55.59 | 16.70 |
| S12 | Lens | −29.1102 | 1.5704 | | | |
| S13 | 7th | 8.1661 | 0.3914 | 1.638 | 22.75 | 16.62 |
| S14 | Lens | 33.6924 | 0.0000 | | | |
| S15 | 8th | 33.6924 | 0.9388 | 1.534 | 70.46 | −10.39 |
| S16 | Lens | 4.7312 | 0.0000 | | | |
| S17 | 9th | 4.7312 | 0.4366 | 1.662 | 20.27 | −1933.82 |
| S18 | Lens | 4.5396 | 0.3969 | | | |
| S19 | Filter | Infinity | 0.1100 | 1.517 | 64.17 | |
| S20 | | Infinity | 1.1877 | | | |
| S21 | Imaging | Infinity | | | | |
| | Plane | | | | | |

According to the third embodiment of the present disclosure, the first lens 310 may have a negative refractive power, an object-side surface may be convex, and an image-side surface may be concave. The second lens 320 may have a positive refractive power, an object-side surface may be convex, and an image-side surface may be concave. The third lens 330 may have a positive refractive power, an object-side surface may be convex, and an image-side surface may be concave. The fourth lens 340 may have a negative refractive power, and an object-side surface may be concave, and an image-side surface may be convex. The fifth lens 350 may have a negative refractive power, an object-side surface and an image-side surface may be concave. The sixth lens 360 may have a positive refractive power, an object-side surface and an image-side surface may be convex. The seventh lens 370 may have a positive refractive power, an object-side surface may be convex, and an image-side surface may be concave. The eighth lens 380 may have a negative refractive power, an object-side surface may be convex, and an image-side surface may be concave. The ninth lens 390 may have a negative refractive power, an object-side surface may be convex, and an image-side surface may be concave.

According to the third embodiment of the present disclosure, the first lens 310, the second lens 320, and the third lens 330 may form a first bonded lens CL1, the fourth lens 340, the fifth lens 350, and the sixth lens 360 may form a second bonded lens CL2, and the seventh lens 370, the eighth lens 380, and the ninth lens 390 may form a third bonded lens CL3.

The first bonded lens CL1 may have a positive refractive power, the second bonded lens CL2 may have a negative refractive power, and the third bonded lens CL3 may have a negative refractive power. A focal length f123 of the first bonded lens CL1 is 8.97 mm, a focal length f456 of the second bonded lens CL2 is-71.86 mm, and a focal length f789 of the third bonded lens CL3 is-31.65 mm.

An object-side surface of the first bonded lens CL1 may be convex, and an image-side surface thereof may be concave. An object-side surface of the second bonded lens CL2 may be concave, and an image-side surface thereof may be convex. An object-side surface of the third bonded lens CL3 may be convex, and an image-side surface thereof may be concave.

According to the third embodiment of the present disclosure, the first lens 310, the third lens 330, the fourth lens 340, the sixth lens 360, the seventh lens 370, and the ninth lens 390 may be made of a polymer material, and the second lens 320, the fifth lens 350, and the eighth lens 380 may be made of a glass material.

The second lens 320, the fifth lens 350, and the eighth lens 380 may be made of respective glass materials having optical characteristics that are different from each other. For example, the second lens 320 made be made of a first glass material, the fifth lens 350 may be made of a second glass material, and the eighth lens 380 made be made of a third glass material. Optical characteristics of the first glass material may be different from optical characteristics of the second glass material and optical characteristics of the third glass material. Also, the optical characteristics of the second glass material may be different from the optical characteristics of the first glass material and the optical characteristics of the third glass material. Also, the optical characteristics of the third glass material may be different from the optical characteristics of the first glass material and the optical characteristics of the second glass material.

The fifth lens 350 may be a high refractive index lens having a refractive index of 1.6 or greater, and among the first lens 310 to the ninth lens 390, the refractive index of the fifth lens 350 may be the greatest.

Among the first lens 310, the second lens 320, and the third lens 330 forming the first bonded lens CL1, a refractive index of the second lens 320 may be the smallest. Among the fourth lens 340, the fifth lens 350, and the sixth lens 360 forming the second bonded lens CL2, a refractive index of the fifth lens 350 may be the greatest. Among the seventh lens 370, the eighth lens 380, and the ninth lens 390 forming the third bonded lens CL3, a refractive index of the eighth lens 380 may be the smallest.

Aspherical coefficients of each lens of the optical imaging system 300 according to the third embodiment of the present disclosure are listed in Table 6 below. According to the third embodiment of the present disclosure, an image-side surface of the first lens 310, an object-side surface and an image-side surface of the second lens 320, and an object-side surface of the third lens 330 may be spherical, an object-side surface of the first lens 310 and an image-side surface of the third lens 330 may be aspherical, and the fourth lens 340 to the ninth lens 390 may have aspherical surfaces on both surfaces (an object-side surface and an image-side surface). Additionally, the first bonded lens CL1, the second bonded lens CL2, and the third bonded lens CL3 may have aspherical surfaces on both surfaces (an object-side surface and an image-side surface).

TABLE 6

| Surface | | | | | | |
|---|---|---|---|---|---|---|
| No. | S1 | S2 | S3 | S4 | S5 | S6 |
| K | −0.033 | 0.000 | 0.000 | 0.000 | 0.000 | 10.890 |
| A | −3.522E−03 | 0.000E+00 | 0.000E+00 | 0.000E+00 | 0.000E+00 | −3.624E−03 |
| B | 1.710E−02 | 0.000E+00 | 0.000E+00 | 0.000E+00 | 0.000E+00 | 1.070E−02 |
| C | −4.833E−02 | 0.000E+00 | 0.000E+00 | 0.000E+00 | 0.000E+00 | −4.271E−02 |
| D | 8.442E−02 | 0.000E+00 | 0.000E+00 | 0.000E+00 | 0.000E+00 | 1.013E−01 |
| E | −9.794E−02 | 0.000E+00 | 0.000E+00 | 0.000E+00 | 0.000E+00 | −1.568E−01 |
| F | 7.890E−02 | 0.000E+00 | 0.000E+00 | 0.000E+00 | 0.000E+00 | 1.642E−01 |
| G | −4.533E−02 | 0.000E+00 | 0.000E+00 | 0.000E+00 | 0.000E+00 | −1.192E−01 |
| H | 1.882E−02 | 0.000E+00 | 0.000E+00 | 0.000E+00 | 0.000E+00 | 6.069E−02 |
| J | −5.660E−03 | 0.000E+00 | 0.000E+00 | 0.000E+00 | 0.000E+00 | −2.160E−02 |
| L | 1.221E−03 | 0.000E+00 | 0.000E+00 | 0.000E+00 | 0.000E+00 | 5.271E−03 |
| M | −1.840E−04 | 0.000E+00 | 0.000E+00 | 0.000E+00 | 0.000E+00 | −8.417E−04 |
| N | 1.839E−05 | 0.000E+00 | 0.000E+00 | 0.000E+00 | 0.000E+00 | 7.974E−04 |
| O | −1.095E−06 | 0.000E+00 | 0.000E+00 | 0.000E+00 | 0.000E+00 | −3.501E−06 |
| P | 2.941E−08 | 0.000E+00 | 0.000E+00 | 0.000E+00 | 0.000E+00 | 1.536E−08 |

| Surface | | | | | | |
|---|---|---|---|---|---|---|
| No. | S7 | S8 | S9 | S10 | S11 | S12 |
| K | 98.982 | −99.043 | −99.043 | −85.744 | −85.744 | 99.000 |
| A | −1.252E−02 | 2.603E−02 | 2.603E−02 | −1.899E−02 | −1.899E−02 | −1.328E−02 |
| B | −3.809E−02 | −1.479E−02 | −1.479E−02 | 2.573E−03 | 2.573E−03 | 1.018E−02 |
| C | 1.821E−01 | 1.295E−03 | 1.295E−03 | −5.267E−04 | −5.267E−04 | −1.589E−02 |
| D | −4.847E−01 | −1.018E−05 | −1.018E−05 | 3.461E−05 | 3.461E−05 | 1.822E−02 |
| E | 8.214E−01 | 0.000E+00 | 0.000E+00 | 0.000E+00 | 0.000E+00 | −1.481E−02 |
| F | −9.449E−01 | 0.000E+00 | 0.000E+00 | 0.000E+00 | 0.000E+00 | 8.603E−03 |
| G | 7.639E−01 | 0.000E+00 | 0.000E+00 | 0.000E+00 | 0.000E+00 | −3.624E−03 |
| H | −4.420E−01 | 0.000E+00 | 0.000E+00 | 0.000E+00 | 0.000E+00 | 1.116E−03 |
| J | 1.840E−01 | 0.000E+00 | 0.000E+00 | 0.000E+00 | 0.000E+00 | −2.507E−04 |
| L | −5.466E−02 | 0.000E+00 | 0.000E+00 | 0.000E+00 | 0.000E+00 | 4.059E−05 |
| M | 1.131E−02 | 0.000E+00 | 0.000E+00 | 0.000E+00 | 0.000E+00 | −4.608E−06 |
| N | −1.547E−03 | 0.000E+00 | 0.000E+00 | 0.000E+00 | 0.000E+00 | 3.476E−07 |
| C | 1.259E−04 | 0.000E+00 | 0.000E+00 | 0.000E+00 | 0.000E+00 | −1.563E−08 |
| P | −4.616E−06 | 0.000E+00 | 0.000E+00 | 0.000E+00 | 0.000E+00 | 3.167E−10 |
| Surface | | | | | | |
| No. | S13 | S14 | S15 | S16 | S17 | S18 |
| K | −97.922 | 35.815 | 35.815 | −31.991 | −31.991 | −10.057 |
| A | 5.865E−03 | −2.048E−02 | −2.048E−02 | −2.630E−03 | −2.630E−03 | −2.081E−03 |
| B | −9.048E−03 | 2.329E−03 | 2.329E−03 | 4.956E−05 | 4.956E−05 | −6.834E−04 |
| C | 4.397E−03 | −1.069E−04 | −1.069E−04 | 0.000E+00 | 0.000E+00 | 2.530E−04 |
| D | −1.504E−03 | 1.814E−06 | 1.814E−06 | 0.000E+00 | 0.000E+00 | −5.562E−05 |
| E | 3.792E−04 | 0.000E+00 | 0.000E+00 | 0.000E+00 | 0.000E+00 | 7.614E−06 |
| F | −7.077E−05 | 0.000E+00 | 0.000E+00 | 0.000E+00 | 0.000E+00 | −5.678E−07 |
| G | 9.788E−06 | 0.000E+00 | 0.000E+00 | 0.000E+00 | 0.000E+00 | 4.008E−09 |
| H | −1.002E−06 | 0.000E+00 | 0.000E+00 | 0.000E+00 | 0.000E+00 | 3.787E−09 |
| J | 7.539E−08 | 0.000E+00 | 0.000E+00 | 0.000E+00 | 0.000E+00 | −4.252E−10 |
| L | −4.103E−09 | 0.000E+00 | 0.000E+00 | 0.000E+00 | 0.000E+00 | 2.494E−11 |
| M | 1.568E−10 | 0.000E+00 | 0.000E+00 | 0.000E+00 | 0.000E+00 | −9.014E−13 |
| N | −3.983E−12 | 0.000E+00 | 0.000E+00 | 0.000E+00 | 0.000E+00 | 2.018E−14 |
| O | 6.032E−14 | 0.000E+00 | 0.000E+00 | 0.000E+00 | 0.000E+00 | −2.578E−16 |
| P | −4.116E−16 | 0.000E+00 | 0.000E+00 | 0.000E+00 | 0.000E+00 | 1.443E−18 |

Table 7 below lists various values of the optical imaging system according to the first to third embodiments of the present disclosure.

TABLE 7

| Value | 1st Embodiment | 2nd Embodiment | 3rd Embodiment |
|---|---|---|---|
| f | 8.91 | 8.97 | 9.31 |
| IMG HT | 6.00 | 6.00 | 6.00 |
| FOV | 66.2° | 65.8° | 63.8° |
| f123 | 8.84 | 9.10 | 8.97 |
| f456 | −5.77 | −151.10 | −71.86 |
| f789 | −47.41 | −30.37 | −31.65 |

Table 8 below lists conditional expression values of the optical imaging system according to the first to third embodiments of the present disclosure.

TABLE 8

| Conditional | 1st | 2nd | 3rd |
|---|---|---|---|
| Expression | Embodiment | Embodiment | Embodiment |
| \|f1/v1 − f2/v2\| | 1.601 | 1.647 | 2.586 |
| \|f2/v2 − f3/v3\| | 0.779 | 0.796 | 3.369 |
| (CT1 + CT3)/CT2 | 0.149 | 0.133 | 0.183 |
| (CT4 + CT6)/CT5 | 0.482 | 0.675 | 0.719 |
| (CT7 + CT9)/CT8 | 0.512 | 0.625 | 0.855 |
| TTL/(2 × IMG HT) | 0.833 | 0.858 | 0.850 |
| f/EPD | 1.988 | 2.419 | 2.120 |
| TTL/f | 1.122 | 1.148 | 1.096 |
| BFL/f | 0.155 | 0.152 | 0.182 |

In an optical imaging system according to an embodiment of the present disclosure, a high resolution may be implemented while reducing the size. In addition, chromatic aberration may be improved.

While this disclosure includes specific examples, it will be apparent after an understanding of the disclosure of this application that various changes in form and detail may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first bonded lens, a second bonded lens, and a third bonded lens sequentially disposed in ascending numerical order along an optical axis of the optical imaging system from an object side of the optical imaging system toward an imaging plane of the optical imaging system and spaced apart from each other by predetermined distances along the optical axis,
wherein each of the first bonded lens, the second bonded lens, and the third bonded lens comprises:
a central lens made of a plastic material or a glass material;
a lens bonded to an object-side surface of the central lens, having a refractive power, and made of a material different from the material of which the central lens is made; and
a lens bonded to an image-side surface of the central lens, having a refractive power, and made of a material different from the material of which the central lens is made.

2. The optical imaging system of claim 1, wherein the first bonded lens has a positive refractive power, the second bonded lens has a negative refractive power, and the third bonded lens has a negative refractive power.

3. The optical imaging system of claim 1, wherein the first bonded lens comprises a first lens, a second lens, and a third lens sequentially disposed in ascending numerical order along the optical axis from an object side of the first bonded lens toward the imaging plane,
the second bonded lens comprises a fourth lens, a fifth lens, and a sixth lens sequentially disposed in ascending numerical order along the optical axis from an object side of the second bonded lens toward the imaging plane,
the third bonded lens comprises a seventh lens, an eighth lens, and a ninth lens sequentially disposed in ascending numerical order along the optical axis from an object side of the third bonded lens toward the imaging plane, and
the second lens, the fifth lens, and the eighth lens are the central lenses of the first bonded lens, the second bonded lens, and the third bonded lens.

4. The optical imaging system of claim 3, wherein the first lens has a negative refractive power, and the second lens has a positive refractive power.

5. The optical imaging system of claim 3, wherein the first lens has a negative refractive power, the second lens has a positive refractive power, and the fifth lens has a negative refractive power.

6. The optical imaging system of claim 3, wherein the fifth lens has a negative refractive power, and
one of the fourth lens and the sixth lens has a positive refractive power, and another one of the fourth lens and the sixth lens has a negative refractive power.

7. The optical imaging system of claim 3, wherein one of the seventh lens and the eighth lens has a positive refractive power, and another one of the seventh lens and the eighth lens has a negative refractive power.

8. The optical imaging system of claim 3, wherein the following conditional expression is satisfied:
$$0 < ( C T n - 1 + C T n + 1 ) / C T n < 1 ( n = 2 , 5 , 8 )$$
where CTn−1 is a thickness of an n−1th lens along the optical axis, CTn is a thickness of an nth lens along the optical axis, and CTn+1 is a thickness of an n+1th lens along the optical axis.

9. The optical imaging system of claim 3, wherein the following conditional expressions are satisfied:
$$\begin{matrix}0 \leq \vert f 1 / v 1 - f 2 / v 2 \vert < 4 \\ 0 \leq \vert f 2 / v 2 - f 3 / v 3 \vert < 4\end{matrix}$$
where f1 is a focal length of the first lens, f2 is a focal length of the second lens, f3 is a focal length of the third lens, v1 is an Abbe number of the first lens, v2 is an Abbe number of the second lens, and v3 is an Abbe number of the third lens.

10. The optical imaging system of claim 3, wherein the following conditional expression is satisfied:
$$0.4 < TTL / ( 2 \times IMG HT ) < 1.$$
where TTL is a distance along the optical axis from an object-side surface of the first lens to the imaging plane, and IMG HT is one half of a diagonal length of the imaging plane.

11. The optical imaging system of claim 3, wherein a refractive index of the fifth lens is greatest among refractive indexes of the first lens to the ninth lens.

12. The optical imaging system of claim 3, wherein the second lens, the fifth lens, and the eighth lens are each made of a plastic material, and
a plastic material of which the fifth lens is made has optical characteristics that are different from optical characteristics of a plastic material of which the second lens is made, and optical characteristics of a plastic material of which the eighth lens is made.

13. The optical imaging system of claim 12, wherein the first to ninth lenses each have an aspheric object-side surface and an aspheric image-side surface.

14. The optical imaging system of claim 3, wherein the second lens, the fifth lens, and the eighth lens are made of respective glass materials having optical characteristics that are different from each other.

15. The optical imaging system of claim 14, wherein either one or both of an object-side surface and an image-side surface of each of the first lens, the second lens, and the third lens is a spherical surface.

16. The optical imaging system of claim 3, wherein the first lens has an aspherical object-side surface and a spherical image-side surface,
the second lens has a spherical object-side surface and a spherical image-side surface,
the third lens has a spherical object-side surface and an aspherical image-side surface, and
the fourth lens to the ninth lens each have an aspherical object-side surface and an aspherical image-side surface.

17. The optical imaging system of claim 3, wherein the first lens, the second lens, the third lens, the seventh lens, the eighth lens, and the ninth lens each have a convex object-side surface in a paraxial region thereof, and
the fourth lens has a concave object-side surface in a paraxial region thereof.

18. The optical imaging system of claim 3, wherein the first lens, the second lens, the third lens, the seventh lens, and the eighth lens each have a concave image-side surface in a paraxial region thereof, and
the sixth lens has a convex image-side surface in a paraxial region thereof.

19. The optical imaging system of claim 1, wherein both the object-side surface and the image-side surface of each of the first bonded lens, the second bonded lens, and the third bonded lens are aspherical surfaces.

20. The optical imaging system of claim 1, wherein the following conditional expression is satisfied:
$$1.5 < f / E P D < 2.5$$
where f is a total focal length of the optical imaging system, and EPD is a diameter of an entrance pupil of the optical imaging system.
